(19) United States
(12) Patent Application Publication
(10) Pub. No.: US 2012/0010938 A1
(43) Pub. Date: Jan. 12, 2012

(54) GEOGRAPHICALLY DEFINED ELECTRONIC COUPON OR VOUCHER DISSEMINATION

(75) Inventors: WILLIAM STANDLEY, San Luis Obispo, CA (US); Anthony Bautista, San Luis Obispo, CA (US)

(73) Assignee: Bazomb, Inc., San Luis Obispo, CA (US)

(21) Appl. No.: 12/833,958

(22) Filed: Jul. 10, 2010

(51) Int. Cl. G06Q 30/00

(52) U.S. Cl. 705/14.36; 705/14.1

(57) ABSTRACT

A computer-implemented process for electronically disseminated coupons or vouchers which confines E-Coupon or E-Voucher dissemination to a merchant's designated market area (DMA) with optional customer “opt-in” in order to participate in the merchant's discount or special promotional offers not generally available to anonymous customers. In one aspect, the computer implemented process is accomplished when a request for an electronically disseminated coupon or voucher from a remote computing device(s) associated with a customer is received by a server. The server determines a geolocation for the remote computing device(s) which is used to validate the request based at least on the customer's geolocation. A validated request causes the server to issue a electronically disseminated coupon or voucher. The issuance of the electronically disseminated coupon or voucher is contemporaneously recorded in a database for invoicing or crediting of the merchant.

### CROSS-REFERENCE AND PRIORITY CLAIM TO RELATED APPLICATIONS

Not applicable.

### RELEVANT FIELD

The present disclosure relates generally to a computer implemented process and more specifically to a computer-implemented process for dissemination of electronic coupons or vouchers in dependence on geolocational information.

### BACKGROUND

Electronic coupons (E-Coupons) and variations thereof are becoming increasingly popular in the relevant art as more consumers take advantage of offers/promotions advertised using the Internet. Many of the E-Coupons offered by a merchant require that a potential customer “opt-in,” that is register with either the merchant or a third party web services provider in order to take advantage of a particular merchant's E-Coupon. The “opt-in” registration process typically requires the potential customer to disclose personal information such as his or her name and a logical and/or physical address in which future offers may be sent to the now enrolled customer. Unfortunately, such enrollment frequently leads to the customer receiving quantities of postal junk mail and/or unsolicited emails (i.e., spam) sent by third parties who have purchased the customer's registration information from the original merchant or the third party web services provider.

Moreover, E-Coupon offers are traditionally made available for large chain stores which have a presence in multiple cities and/or states. This “shotgun” approach is effective for large chain stores but is expensive and ineffective for local merchants who are attempting to attract local customers rather than attempting to appeal to a nationwide customer base. Accordingly, there is a need in the relevant art for a web based service which provides a level of anonymity to a customer and further allows local merchants to cost effectively offer E-Coupons and/or other incentives to a local market of potential customers.

### BRIEF DESCRIPTION OF THE DRAWINGS

The features and advantages of the various exemplary embodiments disclosed herein will become apparent from the following detailed description when considered in conjunction with the accompanying drawings. Where possible, the same reference numerals and characters are used to denote like features, elements, components or portions of various exemplary embodiments. It is intended that changes and modifications can be made to the described exemplary embodiments without departing from the true scope and spirit of the inventive embodiments as defined by the claims.

FIG. 1—depicts a geographical arrangement in which a merchant has defined a designated market area in accordance with an exemplary embodiment.

FIG. 2—depicts a systematic arrangement for implementing an electronic coupon or voucher dissemination system in accordance with an exemplary embodiment.

FIG. 3A—depicts a time sequence diagram for an electronic coupon or voucher dissemination system in accordance with an exemplary embodiment.

FIG. 3B—depicts another time sequence diagram for an electronic coupon or voucher dissemination system in accordance with an exemplary embodiment.

FIG. 4A—depicts a process flow chart for an electronic coupon or voucher dissemination system in accordance with an exemplary embodiment.

FIG. 4B—depicts another process flow chart for an electronic coupon or voucher dissemination system in accordance with an exemplary embodiment.

FIG. 4C—depicts another process flow chart for an electronic coupon or voucher dissemination system in accordance with an exemplary embodiment.

FIG. 5—depicts a block diagram of a computing system for implementing an electronic coupon or voucher dissemination system in accordance with an exemplary embodiment.

### SUMMARY

In view of the foregoing, the various exemplary embodiments described herein address certain of the limitations of the relevant art and provides a computer-implemented process for electronically disseminated coupons or vouchers which limits E-Coupon or voucher distribution to a merchant's designated market area (DMA) and without requiring a potential customer to “opt-in” in order to participate in the merchant's discount incentives. However, if a customer decides to opt-in, additional promotional offers may be made available to those who have voluntarily enrolled with the system. For purposes of this disclosure, an issued coupon provides a customer with a discount off standard prices of a product or service offered by a merchant. Alternately, a voucher is a confirmed purchase receipt for the product or service sold by a merchant.

In various exemplary embodiments disclosed herein, the computer implemented process is embodied on tangible and non-transitory computer readable medium. The tangible and non-transitory computer readable medium comprises instructions which when executed by a physical processor causes the physical processor to perform various processing functions including receiving a request for an electronically disseminated coupon or voucher from a remote computing device(s) associated with a customer; determining a geolocation for the remote computing device(s) and/or an enrollment status of the customer associated with the remote computing device(s), validating the request for the electronically disseminated coupon or voucher in dependence upon the geolocation or the enrollment status of the customer, issuing a billable electronically disseminated coupon or voucher when the request for the electronically disseminated coupon or voucher is validated as a merchant billable event and recording the merchant billable event for the participating merchant contemporaneously with the issuance of the electronically disseminated coupon or voucher.

In an exemplary embodiment, the computer implemented process validates the request for the electronically disseminated coupon or voucher based on one or more criteria. For example, whether the remote computing device(s) is within a predetermined distance from a physical location of the participating merchant; whether a valid PIN associated with the participating merchant has been entered into the remote computing device(s); whether the remote computing device(s) associated with a customer is within a designated market area of the participating merchant when the request for the electronically disseminated coupon or voucher is made; and, whether the enrollment status of the customer includes an address within the designated market area of the participating merchant when the request for the electronically disseminated coupon or voucher and is not repeated within a single session.

Additional validations may be performed by the computer implemented process for determining whether the request for the electronically disseminated coupon or voucher exceeds an authorized per customer issuance limit and/or whether the request for the electronically disseminated coupon or voucher exceeds a time limit (e.g., expired coupon or special offer.)

In an exemplary embodiment, validation of the request for the electronically disseminated coupon or voucher for recording of the coupon billable event does not preclude issuance of a non-billable electronically disseminated coupon redeemable by the participating merchant. The non-billable electronically disseminated coupon allows customers who are not determined to be within the designated market area of the merchant to still participate in discounts and other offers. The validation process may only be required for recording of the billable event for which the merchant is invoiced as part of a fee for service for providing electronic coupon dissemination by a third party web services provider.

In an exemplary embodiment, accounts of customer sponsors are provided credits when the customer causes a billable event to be recorded.

In certain exemplary embodiments where a remote computing device(s) executing a dedicated application is within 20 meters of a physical location of the participating merchant's physical location, the process automatically validates the electronically disseminated coupon or voucher based on locally cached validation information, typically the participating merchant's PIN. In alternate exemplary embodiments, the merchant's PIN may be entered by the participating merchant.

In an exemplary embodiment, the computer implemented process may be performed by a cloud server in processing communications with the remote computing device(s) over one or more telecommunications networks. The one or more telecommunications networks may include but is not limited to a public packet switched network, a cellular telephone network, a wireless local area network and/or a wireless wide area network.

In another exemplary embodiment, a registered customer may opt-in to become a premium member whereby a premium member is offered special promotional offers not available to other members or anonymous users. The special promotional offers allows a premium member to purchase in advance products or services subject to time and quantity constraints. An electronic voucher is issued to the premium member after successful completion of a transaction. In order to become a premium member, a registered customer is typically required to provide charge account information in order to participate in the purchasing of E-Voucher Offers.

In various exemplary embodiments, the remote computing device(s) may be a handheld or a non-handheld computing device, by way of example and not limitation smart phones, personal data assistants, netbooks, laptops, tablet computers, desktop computers, web enabled kiosks and/or video game consoles. The computer-implemented process for geographically defined electronic coupon (E-Coupon) or voucher dissemination may be provided as computer program product, system or as a tangible and non-transient processes.

### DETAILED DESCRIPTION

Various exemplary embodiments of a computer-implemented process for geographically defined electronic coupon (E-Coupon) or voucher dissemination without requiring a potential customer to “opt-in” are described herein. In the following description, for the purposes of explanation, numerous specific details are set forth in order to provide a thorough understanding of the various exemplary inventive features. It will be apparent, however, to a person having ordinary skill in the art that the various exemplary inventive features may be practiced without these specific details. Those customers choosing to opt-in may be provided with additional benefits not available to anonymous users.

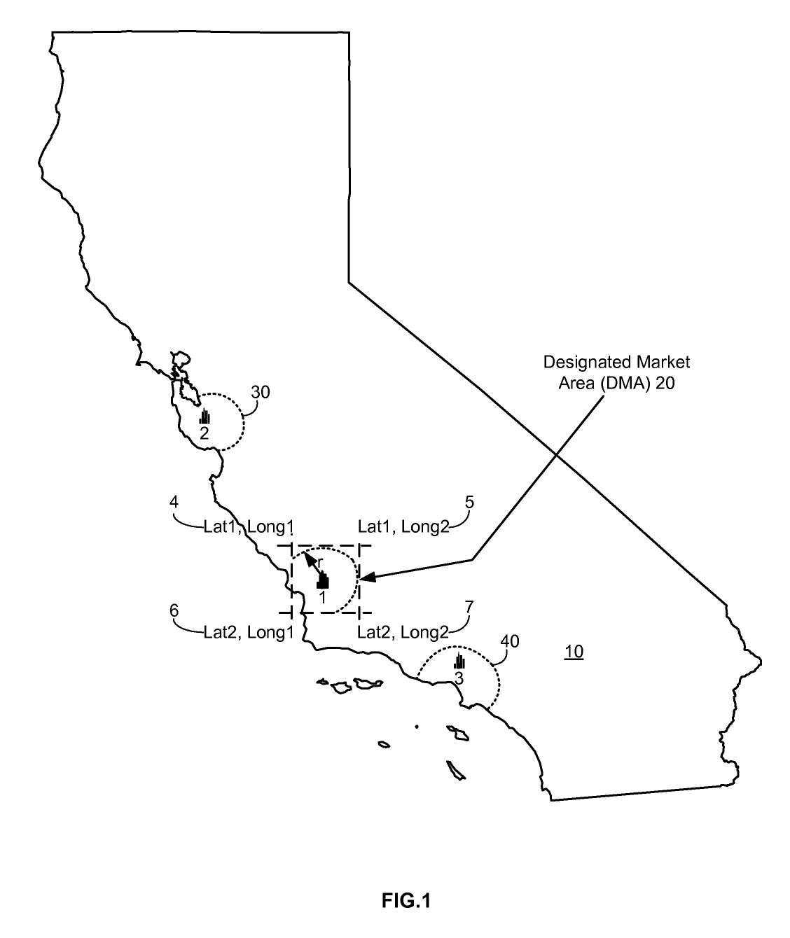

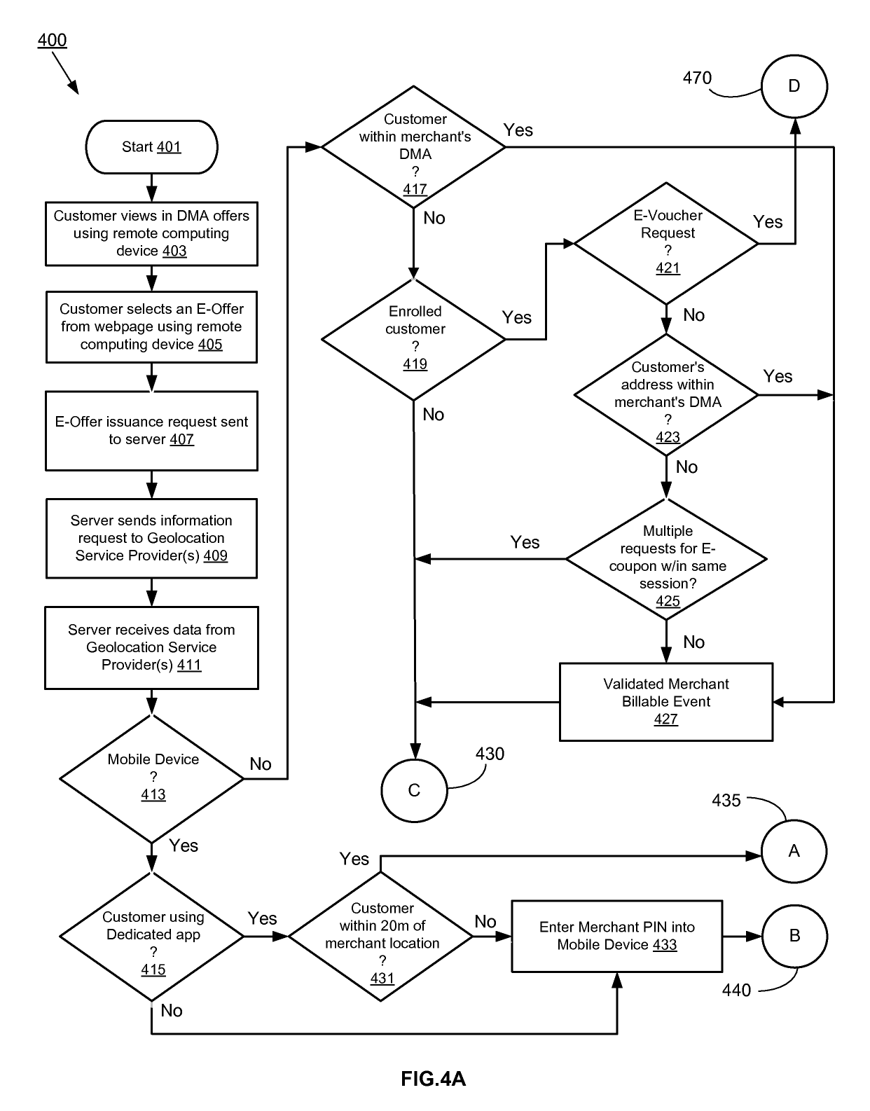

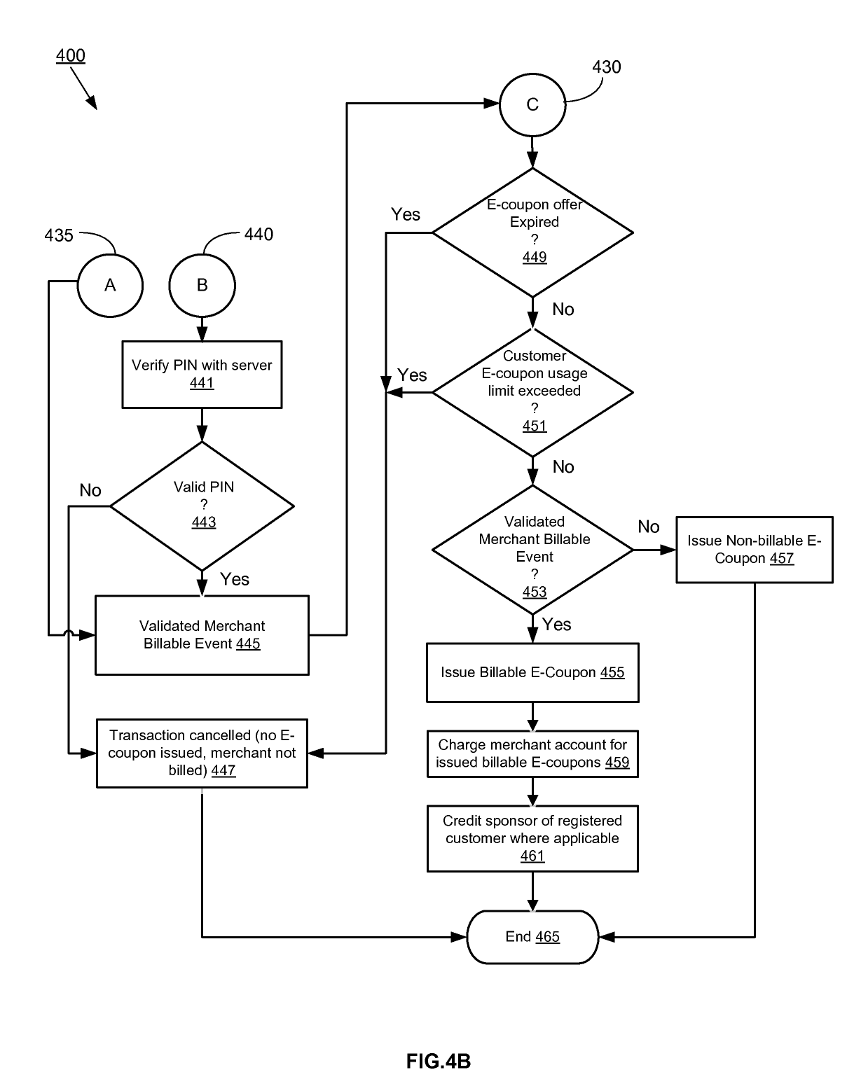

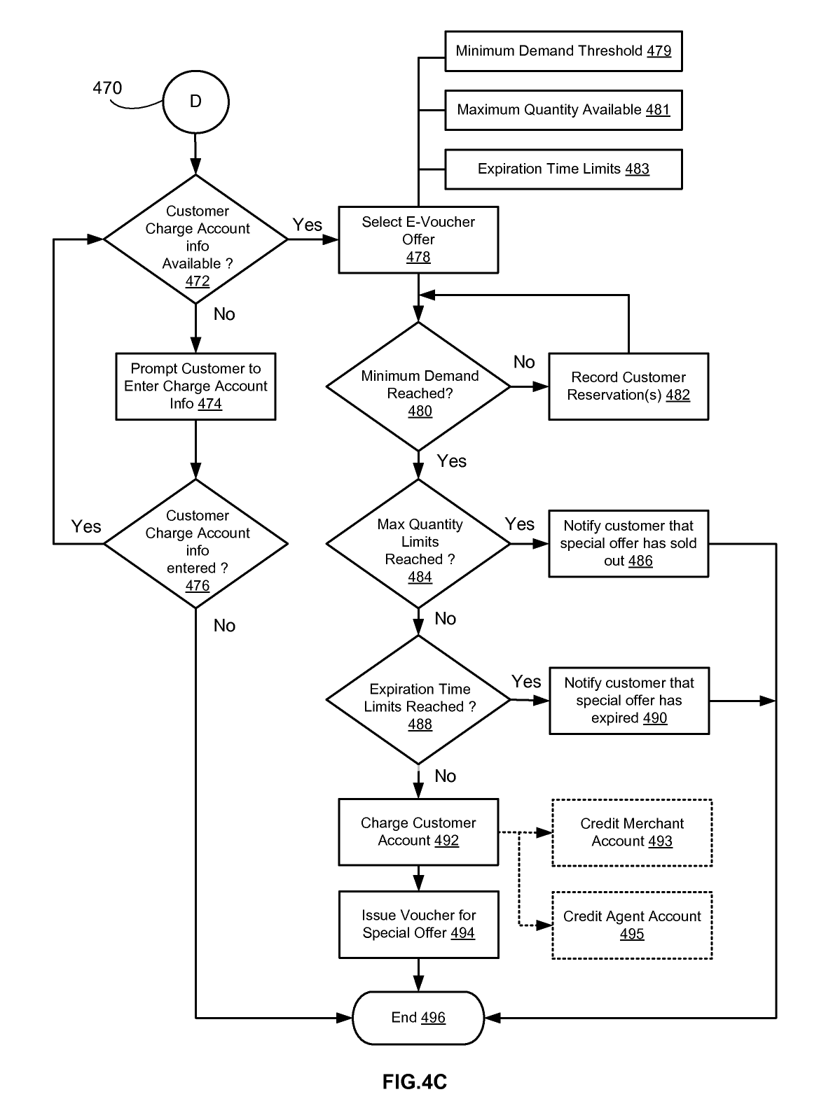

FIG. 1 depicts an geographical arrangement 10 in which a merchant within a city 1 has defined a designated market area (DMA) 20 in accordance with an exemplary embodiment. The DMA 20 is defined by an merchant who may utilize a third web services provider which hosts the computer-implemented process for electronic coupon or voucher dissemination 400 (FIG. 4A,4B,4C). The participating merchant may define his or her DMA 20 based on a number of different criteria including but not limited to an area defined by a range of latitude and longitude coordinates 4,5,6,7; a radius r within city 1, telephone area codes, postal zip codes, internet protocol addresses, cellular telephone coverage areas, global positioning system (GPS) coordinates, Wi-Fi and/or WiMax connection identifiers and/or MAC addresses associated with a customers remote computing device(s)(s). In this example, a merchant located in city 1 has defined his or her DMA 20 based on a set of latitude and longitude coordinates 4,5,6,7. Generally, only customers requesting an electronically disseminated coupon which are determined to be within the merchant's DMA 20 will result in the merchant being invoiced for issuance of an electronically disseminated coupon.

This arrangement does not necessarily preclude potential customers in city 2 and/or city 3 from obtaining redeemable electronically disseminated coupons from the third party web services provider. In this situation, the merchant is not invoiced for electronically disseminated coupons which are not within the merchant's DMA 20. However, restrictions may limit availability of the electronically disseminated coupons or vouchers in certain mobile situations. Alternately, electronically disseminated coupons issued outside the merchant's DMA 20 may have a reduced redemption value in order to further encourage local customer participation.

In this way, the third party web services provider encourages local customers to patronize a local merchant (i.e., within the merchant's DMA) to take advantage of discounts and other offers/promotions provided by the merchant. This allows the local merchant to specifically target his or her local market by providing specific offers and/or promotions which may not be available to potential customers outside of the merchant's DMA 20. As the merchant is defining his or her DMA 20, there is no requirement that potential customers “opt-in” in order to receive the promotions, thus protecting the privacy of the customers, reducing wasteful (i.e., environmentally unfriendly) junk postal mail and/or spam E-mail.

In another exemplary embodiment, the merchant may expand his or her DMA 20 by establishing a physical presence in city 2 or city 3. For example, a successful restaurateur may start a new restaurant in city 2 or city 3 and add separate a DMA 30, 40 for local customers in city 2. In this situation, the merchant will be invoiced for issuance of electronically disseminated coupons for local customers in DMA 20, 30, 40. The customer need not be enrolled in order to take advantage of the merchant's coupon offers and/or promotions. In this way, the customer may remain largely anonymous with exception of the information used to geolocate the customer within the DMA 20 of the merchant.

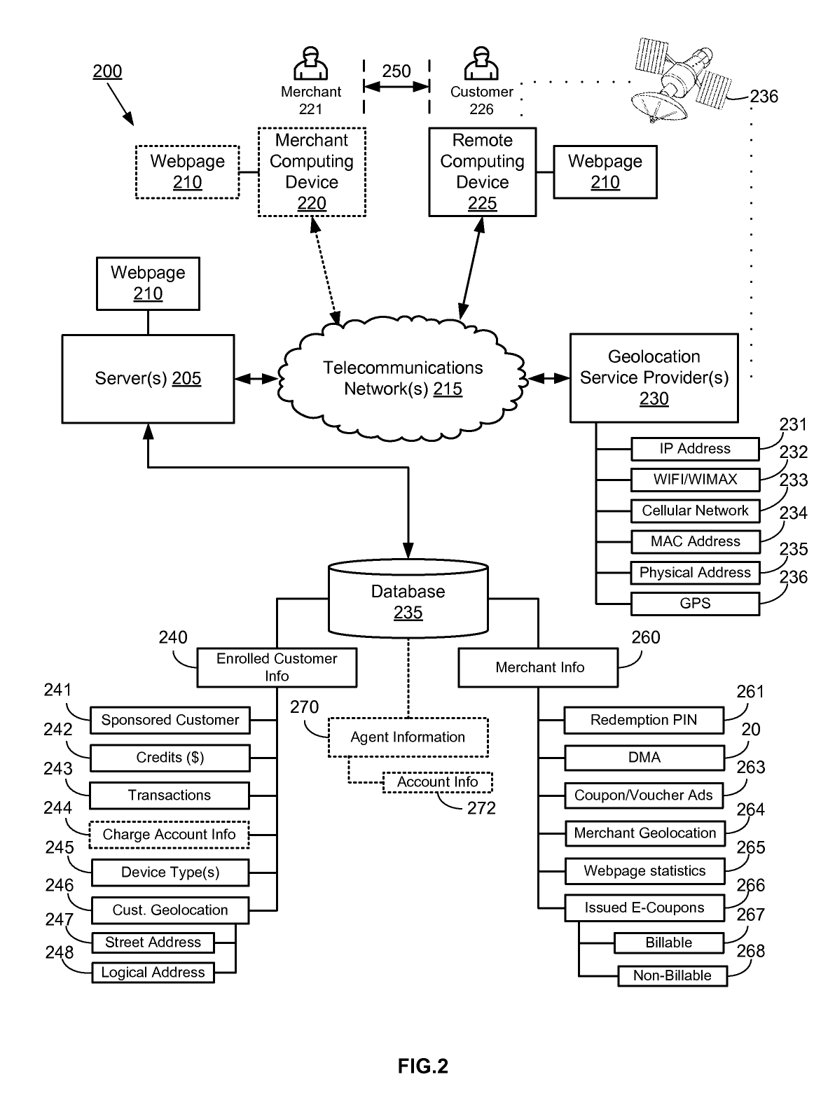

Referring to FIG. 2, a systematic arrangement 200 for implementing a computer implemented process for issuance of an electronically disseminated coupon or voucher in accordance with an exemplary embodiment is depicted. In this exemplary embodiment, a third party web services provider server(s) 205 is configured to execute the computer implemented processes 400 shown in FIGS. 4A,4B,4C. The server(s) 205 is operatively coupled to one or more telecommunications networks 215. The one or more telecommunications networks include the Internet, local wireless networks, wide area wireless networks, and/or cellular networks. The server(s) 205 hosts a webpage for interactions with one or more remote customer computing device(s) 225 and optionally with a merchant computing device 220. One skilled in the art will appreciate that the functionality of the third party web services provider may be implemented directly by a merchant 221.

The merchant 221 may contract with a third party web services provider who administers the server(s) 205 executing the computer implemented processes 400 (FIG. 4A,4B,4C). Relevant merchant information 260 is recorded in a database 235 coupled to the server(s) 205. The merchant information 260 may include a redemption PIN 261 used in the issuance of certain electronically disseminated coupons involving mobile (usually handheld) remote computing device(s). For example, when a merchant PIN is required, the customer 226 may be prompted to have the merchant's PIN entered into his or her remote computing device(s). In an exemplary embodiment, the server(s) 205 is configured as a cloud server.

As previously discussed, the merchant 221 defines a designated market area (DMA) 20. The DMA 20 generally defines the geographical boundaries in which issued electronically disseminated coupons or vouchers result in billable events. The database 235 also stores the merchant's geolocation 264, advertisements, promotions, E-Voucher Offers, voucher promotions and coupons 263 which may be displayed on the webpage 210. Other merchant information 260 accumulated and stored in the database 235 may includes webpage statistics 265. The webpage statistics 265 may include such data as number of visits, visitor locations, time spent viewing the webpage 210, originating IP address, success rate of viewings per electronically disseminated coupon or voucher, number of cancelled transactions and/or other statistical information useful to the merchant 221 for improving target marketing. The database 235 also maintains information concerning E-Coupons 266 including issued billable E-Coupons 267 and optionally issued non-billable coupons 268. The number of issued billable E-Coupons 267 is used in charging an account of the merchant for eventual invoicing and payment by the merchant 221.

The database 235 also maintains enrolled customer information 240. The enrolled customer information 240 includes, where applicable, sponsored customers 241 who receive credits 242 earned from issued billable E-Coupons 267 to their sponsored customer(s) and optionally the number of transactions 243 performed by an enrolled customer. The database 235 may optionally maintain charge account information 244 for certain of the enrolled customers. This account is used to charge a premium enrolled customer for issued E-Vouchers.

The database 235 may also maintain information on the remote computing device types 245 associated with enrolled customers 240. For example, an enrolled customer may own a desktop computing system, a laptop, and a smart phone, all of which may be used to access the webpage 210. In an exemplary embodiment, enrolled customers outside of the DMA 20 may still avail themselves of the webpage 210 by enrolling with the third party web services provider. The enrollment information is stored in the database 235. The customers' geolocation information 246 may include a physical address (street address) 247 and/or logical addresses 248 (IP address, e-mail address, MAC address, etc.) The logical addresses 248 may also be obtained and recorded in the database 235 automatically based on information received from a Geolocation Service Provider(s) 230. In an exemplary embodiment, a Geolocation Service Provider(s) 230 is operatively coupled to the telecommunications network(s) 215.

The server(s) 205 requests geolocation information from the Geolocation Service Provider(s) 230 for determining whether a remote computing device(s) 225 is within the DMA 20 of the merchant. The Geolocation Service Provider(s) 230 may obtain the geolocation of a perspective customer 226 using the IP address 231 of the customer's remote computing device(s) 225, connection information obtained or derived from Wi-Fi or WiMax networks 232, information obtained from cellular network providers 233, the MAC address 234 of the customer's remote computing device(s) 225, a physical address 236 derived from any of the previous geolocation source and/or obtained from a global positioning system 237. In some exemplary embodiments, the customer's geolocation information 264 may also be obtained directly from the customer's remote computing device(s) 225 (e.g., GPS) or user identification header information. In certain exemplary embodiments, the server(s) 205 determines whether the customer's remote computing device(s) 225 is within a predetermined distance 250 of the merchant's physical location. The predetermined distance is defined by the merchant. Under certain circumstances, when the customer's remote computing device(s) 225 is within 20 meters of the merchant's physical location and executing a dedicated application, billable event validation is performed automatically based on the merchant's PIN being securely cached in a memory associated with the customer's remote computing device(s) 225.

In one exemplary embodiment, the database 235 may include third part agent information 270. The third party agent information 270 includes account information 272 for an agent who may receive commissions or other compensation for sales of E-Voucher Offers by merchants and/or acquiring addition merchant membership participation in the service.

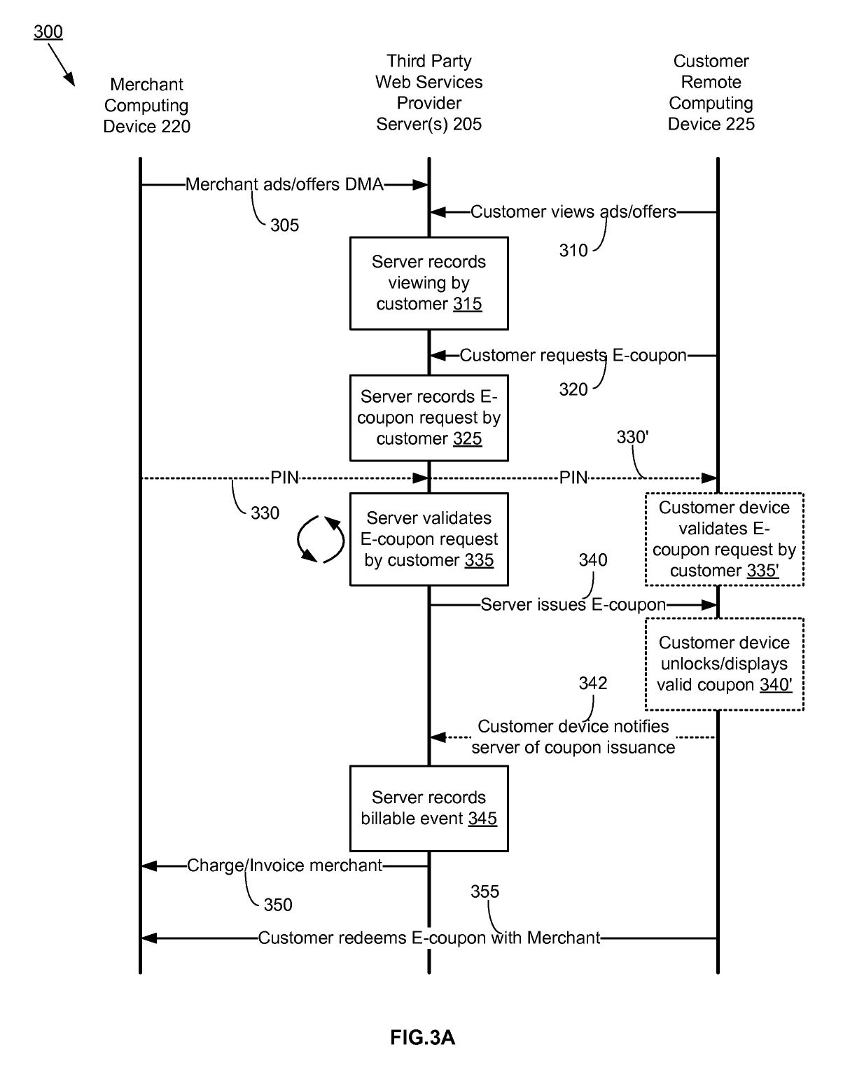

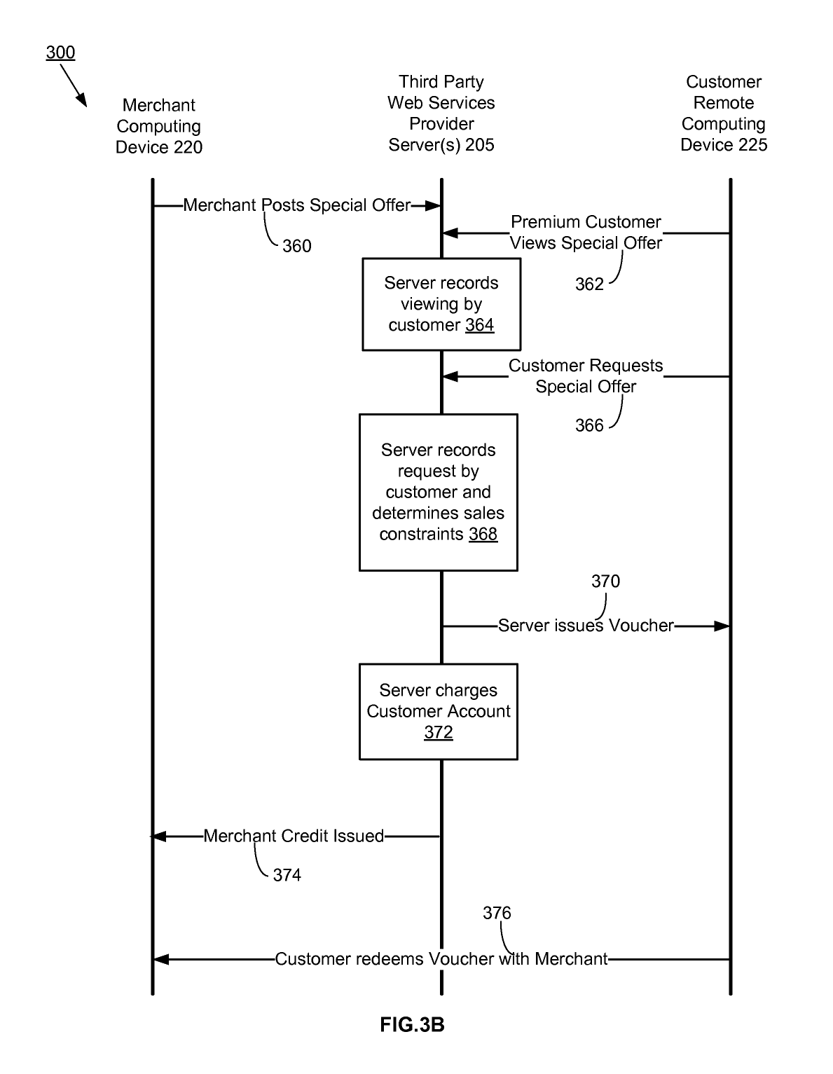

Referring to FIG. 3A, a time sequence diagram 300 for a computer implemented process for issuance of an electronically disseminated coupon or voucher in accordance with an exemplary embodiment is depicted. In this exemplary embodiment, the time sequence diagram 300 is oriented toward coupon issuance whereby a merchant 221 (FIG. 2) may contract with a third party web services provider and causes content to be added to the webpage 210 (FIG. 2) hosted on the server(s) 205 (FIG. 2). The merchant 221 (FIG. 2) may add content directly to the webpage 210 (FIG. 2) or contract with the third party web services provider to accomplish this task. The merchant's content may include advertisements, coupon and voucher offers, special limited offers and/or other promotional information. A potential customer 226 (FIG. 2) using his or her remote computing device(s) 225 (FIG. 2) views the advertisements/offers 310 appearing on the webpage 210. The server(s) 205 may record the prospective customer 226 (FIG. 2) viewing of the webpage 315 in the database 235 (FIG. 2) as part of accumulating webpage statistics 265 for the merchant 221 (FIG. 2). If the customer 226 (FIG. 2) selects a merchant's coupon offer, a request for an E-Coupon 320 is sent to the server(s) 205 (FIG. 2). The server(s) 205 records the customer's E-Coupon request 325 in the database 235 (FIG. 2).

In an exemplary embodiment, when the customer's remote computing device(s) 225 (FIG. 2) is a mobile remote computing device (e.g., smart phone) and is geolocated a predetermined distance 250 (FIG. 2) from the physical location of the merchant 221 (FIG. 2) for automatic validation, a PIN 330 is required to be entered into the customer's remote computing device(s) 225 (FIG. 2) which is typically verified by the server(s) 205 (FIG. 2). The PIN 330 may be either a static PIN chosen by the merchant 221 (FIG. 2) or a one time dynamic PIN generated by the server(s) 205 (FIG. 2) at the time of coupon validation. In an alternate exemplary embodiment, the PIN 330′ may be used to validate and display the valid coupon 340′ directly by the customer's remote computing device(s) 225 (FIG. 2). In this exemplary embodiment, the server(s) 205 (FIG. 2) previously downloaded available coupon offers to the customer's remote computing device(s) 225 (FIG. 2) in a secure format which are not available to the customer 226 (FIG. 2) until unlocked or validated using the merchant's PIN 330′. Common examples of secure formats known in the relevant art include but are not limited to encrypted files, compressed files and password protected files. Transactions between the remote computing device(s) 225 (FIG. 2) and the server(s) 205 are typically conducted using a secure messaging protocol, for example HTTPS, SSL, IPsec, TLS. Alternately, if the customer 226 (FIG. 2) has previously enrolled with the third party web services provider, the server(s) 205 (FIG. 2) may validate the E-Coupon request 335 using enrolled customer information 240 (FIG. 2) stored in the database 235 (FIG. 2).

When the server(s) 205 (FIG. 2) successfully completes validation of the customer's E-Coupon request 335, the server issues an E-Coupon 340 which is sent to the customer's remote computing device(s) 225. Each issued E-Coupon 340 includes a unique code (not shown) generated using a one way hash of the merchant's name and physical location (address) which forms a first part of the unique code. A second part of the unique code is generated from a one way hash of the E-Coupon's database record number which is concatenated with the first part of the unique code. Accordingly, all E-Coupons will include an alphanumeric code which is unique to both the merchant 221 (FIG. 2) and other issued E-Coupons stored in the database 235 (FIG. 2). The one way hash may utilize techniques known in the relevant art including SHA-1, MD5 or other suitable message digest functions.

The server(s) 205 (FIG. 2) contemporaneously records that a billable event 345 has occurred and stores the issued E-Coupon records associated with the merchant information 260 in the database 235 (FIG. 2). Alternately, if the issued E-Coupon 340 has not been validated as a billable event, the server(s) 205 (FIG. 2) contemporaneously records the non-billable event in the non-billable records 268 (FIG. 2) associated with the merchant information 260 in the database 235 (not shown.) In the alternate exemplary embodiment described above, the customer's remote computing device(s) 225 (FIG. 2) notifies the server(s) 205 (FIG. 2) of coupon issuance 342. Assuming that a billable event has occurred, the applicable merchant's account is charged and an invoice 350 is generated and sent to the merchant 220 (FIG. 2). The invoice may be sent electronically or sent out of band (e.g., postal mail) when a sufficient number of billable events have been recorded. The customer may then present the E-Coupon to the merchant for redemption 355.

Referring to FIG. 3B, a time sequence diagram 300 for a computer implemented process for issuance of an electronically disseminated coupon or voucher in accordance with an exemplary embodiment is depicted. In this exemplary embodiment, the time sequence diagram 300 is oriented toward voucher issuance whereby a merchant 221 contracts with a third party web services provider and causes content to be added to the webpage 210 hosted on the server(s) 205. As discussed above, the merchant 221 may add content directly 360 to the webpage 210 or contract with the third party web services provider to accomplish this task. In this exemplary embodiment, the merchant's content is special limited offers and/or other promotional information which is restricted to premium customers.

As will be discussed below with respect to FIG. 4C, a premium customer has actively enrolled and provided charge account information 244 (FIG. 2) with the third party web services provider 205. A premium customer 226 (FIG. 2) using his or her remote computing device(s) 225 views the E-Voucher Offer 362 appearing on the webpage 210. The server(s) 205 may record the premium customer viewing of the webpage 364 in the database 235 as part of accumulating webpage statistics 265 for the merchant 221. If the premium customer 226 requests the E-Voucher Offer, a request for the E-Voucher Offer 366 is sent to the server(s) 205. The server(s) 205 records the premium customer's E-Voucher Offer request 368 in the database 235 and determines whether there are any constraints which would prohibit sale of the E-Voucher Offer to the premium customer. Assuming there are no constraints which would prevent a sale of the E-Voucher Offer, the server(s) 205 issues and sends a voucher 370 to the remote computing device(s) 225. Contemporaneous with the issuance of the voucher, the server(s) 205 charges the customer's account 244 for the price of the E-Voucher Offer 372. The server(s) 205 then sends a portion of the proceeds 374 received from the customer's account to the merchant whose E-Voucher Offer was purchased.

As discussed above, transactions between the remote computing device(s) 225 and the server(s) 205 are typically conducted using a secure messaging protocol. The premium customer may the redeem the voucher with merchant for the product or service sold to the customer 376.

FIG. 4A depicts a process flow chart for an electronic coupon or voucher dissemination 400 within defined geographical boundaries in accordance with an exemplary embodiment. The computer implemented for process electronic coupon or voucher dissemination 400 may be executed by any web enabled computing device, preferably a cloud server. In the discussion which follows, requests for either an electronic coupon or an electronic voucher are referred to herein as an “E-Offer”. Where the computer implemented for process electronic coupon offers and electronic special offers differ, electronic coupons are referred to as “E-Coupon” and electronic vouchers as “E-Voucher.”

The computer implemented for process electronic coupon or voucher dissemination is initiated at block 401 when a customer views offers, promotions, coupons and/or advertisements on a webpage using a display associated with his or her remote computing device(s) 403. At block 405, if an E-Offer appeals to the customer, the customer may select an E-Offer from the webpage 210 (FIG. 2) using a user interface associated with his or her remote computing device(s) 405. At block 407, an E-Offer issuance request is sent from the customer's remote computing device(s) 225 (FIG. 2) over one or more telecommunications network(s) to a server(s) 205 (FIG. 2) executing the computer implemented for process electronic coupon or voucher dissemination 400.

At block 409, upon receipt of the E-Offer issuance request, the computer implemented process for electronic coupon or voucher dissemination 400 generates and sends over the telecommunications network(s) an geolocational information request to one or more Geolocation Service Provider(s) to determine the geolocation of the customer's remote computing device(s) 225 (FIG. 2). The geolocational information request may be formatted as a Simple Object Access Protocol (SOAP) message. The returned geolocational information may also be determinative of the type of remote computing device(s) 225 (FIG. 2) being used by the requesting customer.

The geolocation service provider 230 (FIG. 2) may determine the geolocation of the remote computing device(s) 225 (FIG. 2) using a variety of geo-positioning indicia including the Internet Protocol (IP) address, MAC address, RFID, hardware embedded article/production number, embedded software number (such as UUID, Exif/IPTC/XMP or modern steganography), Wi-Fi or WiMax connection location, GPS coordinates, and/or self-disclosed information. In certain instances where the customer 226 (FIG. 2) is using a mobile remote computing device(s) 225, the returned IP address may be used to determine the cellular provider by a known range of IP addresses associated with a particular cellular network. At block 411, the geolocation results are returned to the server(s) 205 (FIG. 2) executing the computer implemented process for electronic coupon or voucher dissemination from the Geolocation Service Provider(s) 230 (FIG. 2).

At decision block 413, the computer implemented for process electronic coupon or voucher dissemination 400 determines whether the customer's remote computing device(s) is a mobile remote computing device(s) using the geolocation results returned by the Geolocation Service Provider(s) and/or information included in the original E-Offer issuance request. If the geolocation results are representative of a mobile remote computing device(s), the computer implemented for process electronic coupon or voucher dissemination 400 determines at decision block 415 whether the customer's mobile remote computing device(s) is using a dedicated mobile application. The dedicated mobile application provides sufficient information, typically a unique user ID, for the process of electronic coupon or voucher dissemination 400 to identify a enrolled customer which simplifies the E-Offer issuance and validation processes as follows below.

At decision block 431, the computer implemented for process electronic coupon or voucher dissemination 400 determines whether the customer's mobile remote computing device(s) is within twenty (20) meters of the merchant's physical location. If the customer's mobile remote computing device(s) is within twenty (20) meters of the merchant's physical location the computer implemented for process electronic coupon or voucher dissemination 400 continues at continuation block A 435 where information is securely cached in a memory of the customer's mobile remote computing device(s) is used to automatically validate an original E-Coupon issuance request. At block 445 (FIG. 4B), an automatically validated E-Coupon issue request causes the computer implemented for process electronic coupon or voucher dissemination 400 to record a validated merchant billable event 445 in the database 235 (FIG. 2) for the specific merchant 260 (FIG. 2).

Alternately, at decision block 415 (FIG. 4A), if the customer's mobile remote computing device(s) is not using a dedicated mobile application or within twenty meters of the merchant's physical location as determined at decision block 431, the computer implemented for process electronic coupon or voucher dissemination 400 prompts the customer at block 433 to enter a merchant PIN into the customer's mobile remote computing device(s). The computer implemented for process electronic coupon or voucher dissemination 400 continues at continuation block B 440 where the entered PIN is verified at block 441 (FIG. 4B) with the recorded merchant PIN stored in the database 235 (FIG. 2). At decision block 443, if the entered PIN is validated, the computer implemented for process electronic coupon or voucher dissemination 400 records a validated merchant billable event 445 in the database 235 (FIG. 2) for the specific merchant 260 (FIG. 2) as discussed above. Alternately, at decision block 443, if the entered PIN is not validated, typically within three attempts, the computer implemented for process electronic coupon or voucher dissemination 400 cancels the E-Coupon issuance transaction at block 447. A cancelled E-Coupon issuance transaction ends the computer implemented for process electronic coupon or voucher dissemination 400 at block 465 without the merchant incurring a charge for the failed E-Coupon issuance. The cancelled E-Coupon issuance transaction may also be recorded in the customer's transaction records 243 (FIG. 2) included in the database 235.

Alternately at decision block 413 (FIG. 4A), if the computer implemented for process electronic coupon or voucher dissemination 400 determines that the customer's remote computing device(s) is not a mobile remote computing device(s), the computer implemented for process electronic coupon or voucher dissemination 400 next determines at decision block 417 whether the customer's remote computing device(s) is within the geographical limits of the merchant's designated market area (DMA). At decision block 417, if the computer implemented for process electronic coupon or voucher dissemination 400 determines that the customer's remote computing device(s) is within the merchant's DMA 20 (FIG. 2), the computer implemented process for electronic coupon or voucher dissemination 400 records a validated merchant billable event at block 425 in the database 235 (FIG. 2) for the specific merchant 260 (FIG. 2) as discussed above and continues at continuation block C 430. The continuation of the computer implemented for process electronic coupon or voucher dissemination 400 at continuation block C 430 is common for all E-Coupon issuance transactions as will be discussed below.

At decision block 417, if the computer implemented for process electronic coupon or voucher dissemination 400 determines that the customer's remote computing device(s) 225 (FIG. 2) is not within the merchant's DMA, the computer implemented for process electronic coupon or voucher dissemination 400 determines at decision block 419 whether the E-Coupon issuance request was made by a enrolled customer 240 (FIG. 2). At decision block 419, if the E-Coupon issuance request was not made by a enrolled customer, the computer implemented for process electronic coupon or voucher dissemination 400 continues at continuation block C 430 as will be discussed below. Alternately, at decision block 419, if the computer implemented for process electronic coupon or voucher dissemination 400 determines that the E-Coupon issuance request was made by a enrolled customer 240 (FIG. 2), the computer implemented for process electronic coupon or voucher dissemination 400 next determines at decision block 421 whether the enrolled customer has selected a E-Voucher Offer. If at decision block 421, the customer 226 (FIG. 2) has selected a E-Voucher, the computer implemented for process electronic coupon or voucher dissemination 400 continues at continuation block D 470 (FIG. 4C) as will be discussed below. If at decision block 421, the customer 226 (FIG. 2) has not selected an E-Voucher offer, the computer implemented for process electronic coupon or voucher dissemination 400 determines if the customer's enrolled address (physical or logical) is within the merchant's DMA.

At decision block 423, if the computer implemented for process electronic coupon or voucher dissemination 400 determines that the E-Coupon issuance request was made by a enrolled customer 240 (FIG. 2) within the merchant's DMA 263 (FIG. 2), the computer implemented for process electronic coupon or voucher dissemination 400 records a validated merchant billable event at block 427 in the database 235 (FIG. 2) for the specific merchant 260 (FIG. 2) as discussed above and continues at continuation block C 430 as will be discussed below. Alternately, at decision block 423, if the computer implemented for process electronic coupon or voucher dissemination 400 determines that E-Coupon issuance request was made by a enrolled customer but not within the merchant's DMA, the computer implemented for process electronic coupon or voucher dissemination 400 next determines at decision block 425 whether multiple requests for issuance of the same E-Coupon occurred within the same session.

At decision block 425, if multiple requests for issuance of the same E-Coupon occurred within the same session, the computer implemented for process electronic coupon or voucher dissemination 400 continues at continuation block C 430 as will be discussed below. Decision block 425 provides a mechanism to minimize “click fraud,” whereby in pay per click online advertising, a person, automated script or computer program imitates a legitimate customer of a web service clicking on an ad, for the purpose of generating a charge per click without having actual interest in the advertised E-Coupon.

Alternately, at decision block 425, if no multiple requests for issuance of the same E-Coupon occurred within the same session, the computer implemented for process electronic coupon or voucher dissemination 400 records a validated merchant billable event 427 in the database 235 (FIG. 2) for the specific merchant 260 (FIG. 2) as discussed above and continues at continuation block C 430 as is discussed below. At continuation block C 430, the computer implemented for process electronic coupon or voucher dissemination 400 continues at decision block 449. At decision block 449 (FIG. 4B), the computer implemented for process electronic coupon or voucher dissemination 400 determines whether the requested E-Coupon offer has expired. If at decision block 449, the computer implemented for process electronic coupon or voucher dissemination 400 determines that the requested E-Coupon offer has expired, the computer implemented for process electronic coupon or voucher dissemination 400 cancels the E-Coupon issuance transaction at block 447. As previously discussed, a cancelled E-Coupon issuance transaction ends the computer implemented for process electronic coupon or voucher dissemination 400 at block 465 without the merchant incurring a charge for the failed E-Coupon issuance. Alternately, at decision block 449, if the computer implemented for process electronic coupon or voucher dissemination 400 determines that the requested E-Coupon has not expired, the computer implemented for process electronic coupon or voucher dissemination 400 next determines at decision block 451 whether the customer 226 (FIG. 2) has exceeded a E-Coupon usage limit.

If at decision block 451, the computer implemented for process electronic coupon or voucher dissemination 400 determines that the customer 226 (FIG. 2) has exceeded his or her E-Coupon limit, the computer implemented for process electronic coupon or voucher dissemination 400 cancels the E-Coupon issuance transaction at block 447. As previously discussed, a cancelled E-Coupon issuance transaction ends the computer implemented for process electronic coupon or voucher dissemination 400 at block 465 without the merchant incurring a charge for the failed E-Coupon issuance.

Alternately, at decision block 451, if the computer implemented for process electronic coupon or voucher dissemination 400 determines that the customer 226 (FIG. 2) has not exceeded his or her E-Coupon limit, the computer implemented for process electronic coupon or voucher dissemination 400 next determines at decision block 453 whether a validated merchant billable event has occurred at process steps 427 or 445. If the computer implemented for process electronic coupon or voucher dissemination 400 determines at decision block 453, that a validated merchant billable event has not occurred at process steps 427 or 445, the computer implemented for process electronic coupon or voucher dissemination 400 electronically issues at block 457 a non-billable E-Coupon to the requesting customer and ends the computer implemented for process electronic coupon or voucher dissemination 400 at block 465 without the merchant incurring a charge for the issued non-billable E-Coupon issuance. The computer implemented for process electronic coupon or voucher dissemination 400 may contemporaneously record the non-billable event(s) in the billable records 268 (FIG. 2) associated with the merchant information 260 (FIG. 2) in the database 235 (FIG. 2).

Alternately, at decision block 453, if the computer implemented for process electronic coupon or voucher dissemination 400 determines that a validated merchant billable event has occurred at process steps 427 or 445, the computer implemented for process electronic coupon or voucher dissemination 400 electronically issues at block 455 a billable E-Coupon to the requesting customer. At block 459, contemporaneous with the issuance of the billable E-Coupon to the requesting customer at process step 455, the computer implemented for process electronic coupon or voucher dissemination 400 charges an account of the merchant for the issuance of the billable E-Coupon 459. At block 461, the computer implemented for process electronic coupon or voucher dissemination 400 credits a sponsor of a enrolled customer 241 (FIG. 2) for each billable E-Coupon issued to the enrolled customer. The computer implemented for process electronic coupon or voucher dissemination 400 may contemporaneously record the billable event(s) in the billable records 267 associated with the merchant information 260 in the database 235 (FIG. 2). The computer implemented for process electronic coupon or voucher dissemination 400 ends at block 465.

Referring to FIG. 4C, if at decision block 421 (FIG. 4A), the customer 226 (FIG. 2) has selected an E-Voucher offer, the computer implemented for process electronic coupon or voucher dissemination 400 proceeds at continuation block D 470 where at decision block 472, the computer implemented for process electronic coupon or voucher dissemination 400 determines whether the enrolled customer 226 (FIG. 2) has charge account information available 244 (FIG. 2). Enrolled customers 240 (FIG. 2) are invited by the computer implemented for process electronic coupon or voucher dissemination 400 to become premium customers by providing charge account information 244 (FIG. 2) including but not limited to credit card numbers, electronic funds transfer account numbers, debit card numbers, PayPal® account numbers and the like. If at decision block 472, the computer implemented for process electronic coupon or voucher dissemination 400 determines that an enrolled customer 240 (FIG. 2) has not entered charge account information, the enrolled customer 240 (FIG. 2) is prompted at block 474 to enter charge account information. At decision block 476, if the customer declines to enter charge account information, the computer implemented for process electronic coupon or voucher dissemination 400 ends at block 496.

Alternately, if the customer 240 (FIG. 2) has entered charge account information 244 (FIG. 2) at block 474 or has preexisting charge account information 244 present in the database 235 (FIG. 2) at decision blocks 472 or 474 continue on to the E-Voucher sequence shown in block 478. E-Vouchers 478 differ from ordinary discount coupon offers by providing significantly greater savings to an enrolled premium customer. However, the greater discounts provided by E-Voucher Offers may be constrained by one or more of a minimum demand threshold 479 in which the E-Voucher Offer is only valid if a predetermined minimum number of customers select the E-Voucher Offer 479. Another possible constraint is limiting the number of customers who may take advantage of the E-Voucher offer to a predetermined maximum quantity available 481.

Another possible constraint is limiting the E-Voucher Offer to a specific period of time, after which the E-Voucher Offer expires 483. Some or all of these constraints may be made applicable to a particular E-Voucher offer 478. Once a customer selects a E-Voucher Offer at block 478, the computer implemented for process electronic coupon or voucher dissemination 400 determines at decision block 480 whether a sufficient number of requests for the E-Voucher Offer 478 has been received. If a sufficient number of requests for the E-Voucher Offer 478 has not been received, the computer implemented for process electronic coupon or voucher dissemination 400 records the customer's reservation at block 482 in a queue and waits for a sufficient number of requests for the E-Voucher Offer 478 to be received before continuing onto decision block 484. At decision block 484, the computer implemented for process electronic coupon or voucher dissemination 400 determines whether the maximum quantity limit 481 has been reached for the E-Voucher Offer 478. At decision block 484, if the maximum quantity limit 481 has been reached for the E-Voucher Offer 478, the customer is notified at block 486 that the E-Voucher Offer has sold out. In this case, the computer implemented for process electronic coupon or voucher dissemination 400 ends at block 496.

Alternately at decision block 484, if the maximum quantity limit 481 has not been reached for the E-Voucher Offer 478, the computer implemented for process electronic coupon or voucher dissemination 400 determines at decision block 488 whether the E-Voucher Offer has expired due to time limits 483. At decision block 488, if the expiration time limit 483 has been exceeded for the E-Voucher Offer 478, the customer is notified at block 490 that the E-Voucher Offer has expired. In this case, the computer implemented for process electronic coupon or voucher dissemination 400 ends at block 496. Alternately, if the expiration time limit 483 has not been exceeded for the E-Voucher Offer 478, the computer implemented for process electronic coupon or voucher dissemination 400 charges the customer's account at block 492, and issues an electronic coupon voucher at block 494 for the product or service actually purchased online. The electronic coupon voucher 494 may then be redeemed without further payment to the merchant 221 (FIG. 2) by the customer 226 (FIG. 2). In an exemplary embodiment, a portion of the proceeds received from the customer 226 (FIG. 2) at block 492 may be divided and electronically credited to the merchant 493 who offered the E-Voucher Offer at block 478. The remaining portion of the proceeds may be retained by the third party web services provider 205 (FIG. 2) and/or split with a third party agent 495 as a form of commission payment. Once the electronic coupon voucher is issued 494, the computer implemented for process electronic coupon or voucher dissemination 400 ends at block 496.

### Implementation Mechanisms—Hardware Overview

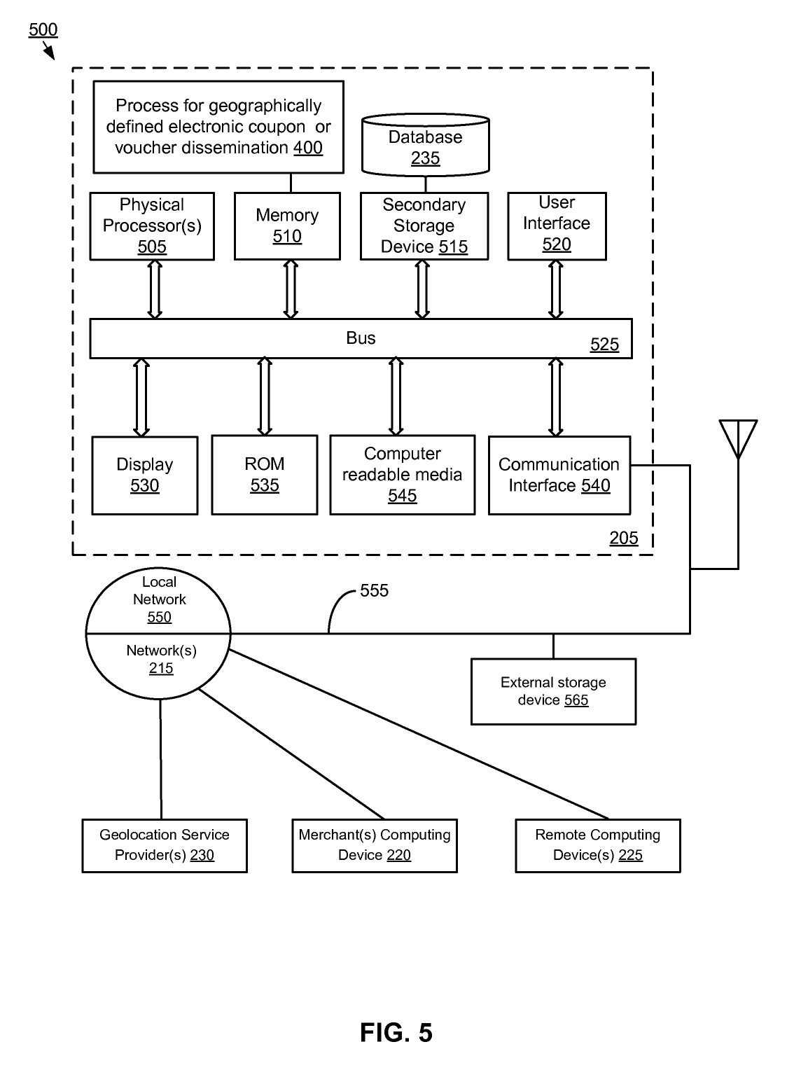

FIG. 5 depicts an exemplary block diagram of a third party web service provider's server(s) 205 upon which inventive embodiments of the computer-implemented process for electronic coupon or voucher dissemination 400 may be implemented. In an exemplary embodiment, the server(s) 205 is implemented as a form of a Turing machine which transforms indicia of customer requests for E-Coupons or E-Vouchers which may be displayed and/or printed by a customer using a remote computing device(s) 225. In an exemplary embodiment, the Turing machine is a web enabled computing system specifically programmed to execute the computer implemented for process electronic coupon or voucher dissemination 400 (FIGS. 4A,4B,4C.)

The server(s) 205 includes a bus 525 or other communication mechanism for communicating information, and one or more physical processors 505 coupled with the bus 525 for processing information. The one or more physical processors 505 may be those manufactured for example by Intel, AMD, Motorola, Texas Instruments or other electronic component manufacturer. The server(s) 205 further includes a main memory 510, such as a random access memory (RAM) and/or other secondary storage device 515 coupled to the bus 525 for storing information and instructions to be executed by the physical processor(s) 505. For example, the computer-implemented process for electronic coupon or voucher dissemination 400. The main memory 510 may also be used for storing temporary variables or other intermediate information during execution of instructions to be executed by the physical processor(s) 505. The server(s) 205 further includes a read only memory (ROM) 535 or other nonvolatile data storage device coupled to the bus 525 for storing static information and instructions for the physical processor(s) 505. A secondary storage device 515, such as a magnetic or optical disk, is provided and coupled to the bus 525 for storing information and instructions. For example, a database 235 may be stored in the secondary memory 515 which is made accessible to the physical processor(s) 505 via the bus 525

The server(s) 205 may be coupled via the bus 525 to a display 530, such as a cathode ray tube (CRT), plasma display, liquid crystal display (LCD) or light emitting diode display (LED), for displaying information to a computer user. One or more user interface devices 520, including a keyboard and/or touch screen is coupled to the bus 525 for communicating information and command selections to the physical processor(s) 505. In an exemplary embodiment, other types of user input device provides cursor control, such as a mouse, a trackball, or cursor direction keys for communicating direction information and command selections to the physical processor(s) 505 and for controlling cursor movement on the display 530.

The various inventive embodiments described above are related to the use of the server(s) 205 for implementing the techniques described herein. According to one inventive embodiment, those techniques are performed by the server(s) 205 in response to the physical processor(s) 505 executing one or more sequences of instructions contained in the main memory 510. Such instructions may be read into the main memory 510 from the secondary storage device 515, or an external storage device 565 coupled to the network(s) 215. Execution of the sequences of instructions contained in the main memory 510 causes the physical processor(s) 505 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer readable media” 545 as used herein refers to any tangible and non-transitory media that participates in providing data that causes the Turing machine to operate in a specific fashion. In an exemplary embodiment implemented using the server(s) 205, various computer readable media 545 are involved, for example, in providing instructions to the physical processor(s) 505 for execution. Such a medium may take many forms, including but not limited to non-volatile storage media. Computer readable media 545 includes tangible and non-transient media.

Common forms of tangible non-transient computer readable media 415 include, for example, a floppy disk, a flexible disk, hard disk, magnetic tape, or any other magnetic medium, a CD-ROM, DVD, any other optical medium, punch cards, paper tape, any other physical medium with patterns of holes, a RAM, a PROM, and EPROM, a FLASH-EPROM, EEPROM, FLASH-RAM and/or any other memory chip or cartridge as described hereinafter, or any other medium from which a processor of a computer can read.

Various forms of computer readable media may be involved in carrying one or more sequences of instructions to the physical processor(s) 505 for execution. For example, the instructions may initially be carried on a magnetic disk of a remote computing device(s) 225. A remote computing device(s) 225 can load the instructions into its dynamic memory and send the instructions over the network(s) 215, 550. A communication interface 540 is coupled to the bus 525 of the server(s) 205 and can receive and convert the data to a form which can be transferred to the bus 525. The bus 525 carries the data to main memory 510, from which the physical processor(s) 505 retrieves and executes the instructions. The instructions received by the main memory 510 may optionally be stored on the secondary storage 515 or an external electronic storage device 565 either before or after execution by the physical processor(s) 505.

The communication interface 540 provides a two-way data communication coupling to a network link 555 that is connected to one or more networks 215, 550. For example, the communication interface 540 may be an integrated services digital network (ISDN) card or a digital subscriber line (DSL) or cable modem to provide a data communication connection to a corresponding type of telephone line or cable. As another example, the communication interface 540 may be a local area network (LAN) card to provide a data communication connection to a compatible LAN.

Wireless links may also be implemented. In any such implementation, the communication interface 540 sends and receives electrical, electromagnetic and/or optical signals that carry digital data streams representing various types of information. The communications link 555 typically provides data communication through one or more networks 215, 550 to other data devices. For example, the communications link 555 may provide a connection through the network 215 to a remote computing device(s) 225, a merchant computing device 220 and/or a Geolocation Service Provider(s) 230 (FIG. 2). The communications link 555 and the network(s) 215, 550 may use electrical, electromagnetic and/or optical signals that carry digital data streams. The server(s) 205 can send messages and receive data, including program code, through the networks 215, 550, the communications link 555 and the communication interface 540. The received code may be executed by the physical processor(s) 505 as it is received, and/or stored in the secondary storage device 515 or on computer readable media 545, or other non-volatile storage for later execution.

Where necessary, computer programs, applications, algorithms and routines are envisioned to be programmed in a high level language object oriented language, by way of example and not limitation, Apache Cocoon, Java, C, C++, C#, CORBA, Visual Basic, JavaScript, Perl, and/or Python. Database components may utilize any common database program, by way of example and not limitation, ORACLE, MSSQL, MySQL, SQL, MS ACCESS, DB2, MS FOXBASE, DBASE, PostgreSQL and RBASE.

For purposes of this disclosure, the term “program” is intended to be interpreted in its broadest sense to include all instructions executable by a processor whether embodied in hardware or software. Where applicable, references to various programs may be made in both singular and plural form. No limitation is intended by such grammatical usage as one skilled in the art will appreciate that multiple programs, applications, processes, objects, subprograms, subroutines, algorithms, applets, contexts, order of process execution, etc. may be implemented programmatically to implement the various inventive embodiments.

### Extensions and Alternatives

In the foregoing specification, the various exemplary inventive features have been described with reference to specific embodiments herein. It will, however, be appreciated by a person having ordinary skill in the art that various modifications and changes may be made thereto without departing from the broader spirit and scope of the various inventive embodiments disclosed. The specification and drawings are, accordingly, to be regarded in an exemplary rather than a restrictive sense. Any definitions expressly set forth herein for terms contained in such claims shall govern the meaning of such terms as used in the claims. Hence, no limitation, sequence of operation, element, property, feature, advantage or attribute that is not expressly recited in a claim should limit the scope of such claim in any way.

What is claimed:

1. A computer implemented process for issuance of an electronically disseminated coupon or voucher comprising:
receiving a request for an electronically disseminated coupon or voucher from a remote computing device associated with a customer;
determining a geolocation for the remote computing device or an enrollment status of the customer associated with the remote computing device;
validating the request for the electronically disseminated coupon or voucher in dependence upon the geolocation or the enrollment status of the customer;
issuing a billable electronically disseminated coupon or voucher when the request for the electronically disseminated coupon or voucher is validated as a merchant billable event;
recording the merchant billable event for a participating merchant contemporaneously with the issuance of the billable electronically disseminated coupon.

2. The computer implemented process of claim 1 wherein validating the request for the electronically disseminated coupon or voucher comprises one of:
determining whether the remote computing device is within a predetermined distance from a physical location of the participating merchant;
determining whether a valid PIN associated with the participating merchant has been entered into the remote computing device;
determining whether the remote computing device is within a designated market area of the participating merchant and the request for the electronically disseminated coupon or voucher is not repeated within a single session;
determining whether the enrollment status of the customer includes an address within the designated market area of the participating merchant and the request for the electronically disseminated coupon or voucher is not repeated within a single session.

3. The computer implemented process of claim 1 wherein validating the request for the electronically disseminated coupon or voucher comprises one of:
determining whether the request for the electronically disseminated coupon or voucher exceeds an authorized per customer issuance limit;
determining whether the request for the electronically disseminated coupon or voucher exceeds a time limit.

4. The computer implemented process of claim 1 wherein validation of the request for the electronically disseminated coupon or voucher for recording of the billable event does not preclude issuance of a non-billable electronically disseminated coupon or voucher redeemable by the participating merchant.

5. The computer implemented process of claim 1 wherein validation of the request for the electronically disseminated coupon or voucher is only required for recording of the billable event.

6. The computer implemented process of claim 1 further comprising:
crediting an account of a sponsor of the customer associated with the remote computing device contemporaneously with recording the merchant billable event for the participating merchant.

7. The computer implemented process of claim 2 wherein the determining whether the remote computing device is within the predetermined distance from the participating merchant's physical location is dependent on the customer's remote computing device executing a dedicated application.

8. The computer implemented process of claim 8 wherein the predetermined distance is within 20 meters of the participating merchant's physical location.

9. The computer implemented process of claim 1 wherein the issuance of electronically disseminated coupons is performed by a cloud server in processing communications with the remote computing device over one or more telecommunications networks.

10. The computer implemented process of claim 2 wherein the PIN is entered into the customer's remote computing device by the participating merchant.

11. A computer implemented process for issuance of an electronically disseminated coupon or voucher comprising:
receiving a request for an electronically disseminated coupon or voucher from a remote computing device associated with a customer;
determining a geolocation for the remote computing device or an enrollment status of the customer associated with the remote computing device;
validating the request for the electronically disseminated coupon or voucher in dependence upon the geolocation or the enrollment status of the customer;
issuing a billable electronically disseminated coupon or voucher only when the request for the electronically disseminated coupon or voucher is validated as a merchant billable event;
recording the merchant billable event for a participating merchant contemporaneously with the issuance of the billable electronically disseminated coupon;
wherein the merchant billable event is limited to either a designated market area of the participating merchant or the enrollment status of the customer.

12. The computer implemented process of claim 11 further comprising:
issuing a non-billable electronically disseminated coupon or voucher for an enrolled customer in which the request for the electronically disseminated coupon or voucher originated outside of the participating merchant's designated market area.

13. The computer implemented process of claim 11 wherein the designated market area is defined by the participating merchant.

14. The computer implemented process of claim 11 further comprising:
preventing issuance of the electronically disseminated coupon or voucher when;
the request for the electronically disseminated coupon or voucher has expired;
an issuance limit for the electronically disseminated coupon or voucher has been exceeded; or,
a PIN entry is determined to be invalid.

15. The computer implemented process of claim 13 wherein the designated market area is defined by the merchant using any of;
latitude and longitude coordinates;
a radial distance from a merchant's physical location;
postal codes;
one or more predefined geographical regions.

16. The computer implemented process of claim 11 further comprising:
validating a PIN entry when a dedicated application is executing on a customer's mobile remote computing device when the customer's mobile remote computing device is greater than a predetermined distance from a merchant's physical location.

17. The computer implemented process of claim 16 wherein no PIN entry is required when the customer's mobile remote computing device executing the dedicated application is within the predetermined distance from the merchant's physical location.

18. A computer implemented process for issuance of an electronically disseminated coupon or voucher comprising:
receiving a request for an electronically disseminated coupon or voucher from a remote computing device associated with a customer;
determining a geolocation for the customer's remote computing device;
validating the request for the electronically disseminated coupon or voucher in dependence upon the geolocation of the customer;
issuing a billable electronically disseminated coupon or voucher only when the request for the electronically disseminated coupon or voucher is validated as a merchant billable event;
recording the merchant billable event for a participating merchant contemporaneously with the issuance of the billable electronically disseminated coupon;
wherein the merchant billable event is limited to a designated market area defined by the participating merchant.

19. The computer implemented process of claim 18 wherein validating the request for the electronically disseminated coupon or voucher is accomplished without customer enrollment.

20. The computer implemented process of claim 19 wherein customer enrollment is optional.

21. A computer implemented process for issuance of an electronically disseminated coupon or voucher comprising:
receiving a request for an electronically disseminated coupon or voucher from a remote computing device associated with a customer;
determining a geolocation for the customer's remote computing device;
determining whether the request for the electronically disseminated coupon or voucher is for an electronically disseminated coupon or voucher.

22. The computer implemented process of claim 21 further comprising:
when the request is determined to be for an electronically disseminated coupon, validating the request for the electronically disseminated coupon or voucher in dependence upon the geolocation of the customer;
issuing a billable electronically disseminated coupon or voucher only when the request for the electronically disseminated coupon or voucher is validated as a merchant billable event;
recording the merchant billable event for a participating merchant contemporaneously with the issuance of the billable electronically disseminated coupon;
wherein the merchant billable event is limited to a designated market area defined by the participating merchant.

23. The computer implemented process of claim 21 further comprising:
when the request is determined to be for an electronically disseminated voucher, determining whether the customer is a premium enrolled customer;
determining whether any constraints prohibit purchasing of the electronically disseminated voucher;
charging an account of the premium enrolled customer when purchasing of the electronically disseminated voucher is permitted;
issuing the electronically disseminated voucher to the premium customer.

24. The computer implemented process of claim 22 wherein the constraints include any of;
a minimum demand for the purchase of the electronically disseminated voucher;
a maximum available quantity limit for the electronically disseminated voucher;
a time limit in which to purchase the electronically disseminated voucher.

25. The computer implemented process of claim 23 further comprising:
crediting a merchant account with at least a portion of proceeds received from the charging of the premium enrolled customer's account.

26. The computer implemented process of claim 23 wherein the account of the premium enrolled customer includes a credit card account, an electronic funds transfer authorization, a third party financial exchange account and a third party credit account.

27. A computing system configured to execute the computer implemented process of claim 1.

28. A computer program product embodied on a tangible and non-transitory computer readable medium comprising instructions which when executed by a physical processor causes a physical processor to perform the computer implemented process of claim 1.
